(19) United States
(12) Patent Application Publication
(10) Pub. No.: US 2007/0191502 A1
(43) Pub. Date: Aug. 16, 2007

(54) Hydrophilic ester polyurethane foams

(75) Inventors: Sharon A. Free, Wallingford, PA (US); Joseph C. Bertolini, Mullica Hill, NJ (US); Chiu Y. Chan, Wilmington, DE (US); Marc J. Albero, Springfield, PA (US)

Correspondence Address: CONNOLLY BOVE LODGE & HUTZ, LLP, P O BOX 2207, WILMINGTON, DE, 19899, US

(73) Assignee: FOAMEX L.P., Linwood, PA (US)

(21) Appl. No.: 11/353,816

(22) Filed: Feb. 14, 2006

(51) Int. Cl. C08G 18/00

(52) U.S. Cl. 521/172

(57) ABSTRACT

An ester polyurethane foam is prepared by reacting one or a mixture of hydrophilic polyester polyols with one or more isocyanates and a cell opening surfactant. The cured foam does not require post-foaming processing to achieve a water absorption rate of at least 20 pounds of water per square foot per minute, preferably at least 25 pounds of water per square foot per minute. The foam may be bonded to a substrate to form an absorbent article, such as a sponge, mop head, or a medical or industrial wipe.

This invention relates to certain ester polyurethane foam compositions that have unexpectedly improved liquid absorption and wicking properties. The foams may be incorporated into articles used to wipe and absorb liquids, such as household cleaning sponges and mop heads, and medical, clean room or industrial wipes.

### BACKGROUND OF THE INVENTION

Household cleaning sponges and mop heads most commonly are formed from cellulose. Paper pulp is the primary ingredient for cellulose sponges. The pulp is reacted with carbon disulfide to form a soluble cellulose xanthate compound. This compound is dissolved into a honey-like liquid viscose and mixed with reinforcing fibers to add strength to the pulp mixture. The cellulose is formed with a double cell structure to replicate natural sea sponges. Sodium sulfate crystals are added to the pulp, and this mixture is heated in a mold to melt the crystals. Heating regenerates the mix to pure cellulose and leaves the signature sponge holes where the crystals have melted away. Bleaching chemicals and humectants maintain the moisture level and color purity of the cellulose sponge. While the cellulose has good water absorption and wicking, it has lower wet integrity than other materials. Moreover, upon drying, the cellulose becomes hard and brittle such that it must be pre-wet before using for wiping.

Open celled ester and ether polyurethane foams have greater softness and flexibility than cellulose, and retain flexibility upon drying without humectants. As compared to cellulose, foams have greater wet strength, better wet integrity and exhibit less swelling when wet. Foams also can be foamed to have a double cell structure to more resemble natural sea sponges. Generally, polyurethane foams can be produced more cheaply than cellulose. However, polyurethane foams are hydrophobic, lacking good liquid absorption and wicking characteristics, which makes them less suitable for household sponges, mop heads and cleaning wipes. Even after the polyurethane foams are post-treated with surfactants in an attempt to improve water absorption and wicking, they still do not match the performance of cellulose for these properties.

U.S. Pat. No. 6,756,416 teaches hydrophilic ester polyurethane foams made with a chemical reticulation post-processing step. These foams have excellent water absorbing and wicking performance and are suitable for use as components of sponges and mop heads. However, the chemical reticulation step adds additional processing time and cost. The foam contacts the caustic solution bath for a sufficient time to dissolve cell walls, then is rinsed and dried thoroughly before it can be fabricated into a final part. These steps add to the cost and burden of production planning. Furthermore, the chemically reticulated foams can have lower flame lamination bond strength. It therefore would be highly desirable to produce a hydrophilic foam that does not require such chemical reticulation post-processing, and preferably to product a hydrophilic foam that does not require any post-foaming steps prior to lamination to form a finished product.

### SUMMARY OF THE INVENTION

According to the invention, a hydrophilic polyester polyurethane foam is made by reacting one or more polyols with one or more isocyanates in the presence of a catalyst. In the present invention, at least about 40 parts by weight of the 100 parts polyol comprises a hydrophilic polyester polyol with an hydroxyl number of 40 to 100. Typically, the recipes for polyurethane foams are expressed in terms of parts by weight per 100 parts polyol. Thus, for each 100 parts by weight of a polyester polyol or mixture of polyols, the foam formulation according to the invention includes: from at least about 30.0 parts by weight of an isocyanate; from 1.5 to 5.0 parts of a blowing agent, such as water; from 0.5 to 2.0 parts of a blow catalyst; from 0 to 0.3 parts of a gel catalyst, and up to 3.0 parts of a cell opening surfactant, such as a stabilizing silicone surfactant. Other additives such as antimicrobial additives, double cell additives, dyes, pigments, colorants, crosslinking additives, fragrances, detergents and extenders may also be incorporated into the foam formulation.

After the foam forming components have been mixed together, the foam is permitted to rise and cure, preferably under atmospheric temperature and pressure. The resulting foam has pore sizes preferably in the range of from 70 to 130 pores per linear inch, most preferably 70 to 90 pores per linear inch, but may also have a double cell or sea sponge-like structure. The preferred double cell structure has a distribution of larger and medium sized cells scattered across a background of finer cells. The larger cells may range from 0.06 to 0.09 inches in diameter.

The cured foam has been found to have surprisingly good water absorbing properties without any further treatment. The finished foams with the composition described by this invention have good wicking characteristics that will absorb water at a rate of at least 20 pounds of water per square foot per minute, preferably at least 25 pounds of water per square foot per minute, most preferably at least 35 pounds of water per square foot per minute. The foam also has greater water holding capacity and wet strength than cellulose. The hydrophilic ester polyurethane foam does not swell appreciably upon absorbing and retaining liquids and would make an ideal component of an absorbent article, such as a household sponge, mop head or medical or industrial wipe.

The hydrophilic properties of the inventive foams are much improved over conventional polyester polyurethane foams, and are nearly as good as polyester foams that have been chemically treated as described in U.S. Pat. No. 6,756,416. Thus, such foams may be used after curing and without the need for an additional chemical treatment to improve hydrophilic properties.

### DESCRIPTION OF THE PREFERRED EMBODIMENTS

Hydrophilic ester foams according to the invention are prepared preferably by mixing together the polyol component with the surfactants, catalysts, blowing agents and other additives, forming a polyol pre-mix. To the polyol pre-mix is added the isocyanate component. The foam mixture is then allowed to rise and cure, preferably under atmospheric conditions, to form the hydrophilic ester polyurethane foam.

Polyester polyurethane foams are more hydrophilic than polyether polyurethane foams due to the increased polarity of the carboxylic acid groups. Suitable polyester polyols for producing flexible polyester polyurethane foams are well known in the industry. Illustrative of such suitable polyester polyols are those produced by reacting a dicarboxylic and/or monocarboxylic acid with an excess of a diol and/or polyhydroxy alcohol, for example, adipic acid, glutaric acid, succinic acid, phthalic acid or anhydride, and/or fatty acids (linolic acid, oleic acid and the like) with diethylene glycol, ethylene glycol, propylene glycol, dipropylene glycol, 1,4-butanediol, neopentyl glycol, trimethylolpropane, trimethylolethane, and/or pentaerythritol. Examples of these polyols are LEXOREZ 1102-50 or LEXOREZ 1102-60 from Inolex Chemical Company or FOMREZ 50 or FOMREZ 60 from Crompton Corporation. Other suitable polyester polyols can be prepared by reacting a lactone with an excess of a diol such as caprolactone with propylene glycol. See U.S. Pat. No. 4,331,555 for further discussion of suitable polyester polyols. Preferably, the polyester polyol is made by reacting adipic acid and ethylene glycol monomers with a glycerin initiator. Hydrophilic ester polyols are typically reaction products of polyethylene glycol and adipic acid. Examples are FOMREZ 45 from Crompton and LEXOREZ 1105-HV2 from Inolex Chemical Company. Most preferably, the polyol component of the foam-forming mixture of the invention comprises at least forty (40) parts by weight, preferably one hundred (100) parts by weight, of a hydrophilic ester polyol with a hydroxyl number of 40 to 100. If a polyol mixture of the hydrophilic ester polyols with one or more other polyols is used, the additional polyol component of such mixture can be a 40 to 100 hydroxyl ester polyol, or a mixture of hydroxyl ester polyols.

The “hydroxyl number” for a polyol is a measure of the amount of reactive hydroxyl groups available for reaction. The value is reported as the number of milligrams of potassium hydroxide equivalent to the hydroxyl groups found in one gram of the sample. “Functionality” of a polyol is defined as the average number of hydroxyl group sites per molecule. Preferably, the polyester polyols used to form the foams of the present invention have a hydroxyl number in the range of 20 to 150, more preferably in the range of 40 to 100, and most preferably in the range of 50 to 60.

The term “polyisocyanate” refers particularly to isocyanates that have previously been suggested for use in preparing polyurethane foams. “Polyisocyanates” include di- and polyisocyanates and prepolymers of polyols and polyisocyanates having excess isocyanate groups available to react with additional polyol. The amount of polyisocyanate employed is frequently expressed by the term “index”, which refers to the actual amount of isocyanate required for reaction with all of the active hydrogen-containing compounds present in the reaction mixture multiplied by 100. For most foam applications, the isocyanate index is in the range of between about 60 to 140. In this invention, the preferred isocyanate index is in the range of 60 to 110, most preferably 100 or below, with a particularly preferred range of 70 to 90.

The polyester polyurethane foams are prepared using any suitable organic polyisocyanates well known in the art including, for example, hexamethylene diisocyanate, phenylene diisocyanate, toluene diisocyanate (TDI) and 4,4′-diphenylmethane diisocyanate (MDI). The methylene diisocyanates suitable for use are diphenyl methane diisocyanate and polymethylene polyphenyl isocyanate blends (sometimes referred to as “MDI” or “polymeric MDI”). The MDI blends can contain diphenylmethane 4, 4′diisocyanate, as well as 2,2′ and 2, 4′ isomers and higher molecular weight oligomers and have an isocyanate functionality of from about 2.1 to 2.7, preferably from about 2.1 to 2.5. Preferably, the isocyanate is selected from a commercial mixture of 2,4- and 2,6-toluene diisocyanate. A well-known commercial toluene diisocyanate is TD80, a blend of 80% 2, 4 toluene diisocyanate and 20% 2, 6 toluene diisocyanate. Polyisocyanates are typically used at a level of between 20 and 90 parts by weight per 100 parts of polyol, depending upon the polyol OH content and water content of the formulation.

One or more surfactants are also employed in the foam-forming composition. The surfactants lower the bulk surface tension, promote nucleation of bubbles, stabilize the rising cellular structure, emulsify incompatible ingredients, and may have some effect on the hydrophilicity of the resulting foam. The surfactants typically used in polyurethane foam applications are polysiloxane-polyoxyalkylene copolymers, which are generally used at levels between about 0.5 and 3 parts by weight per 100 parts polyol. In the present invention, from 1.0 to 3.0 parts by weight per 100 parts polyol of a hydrophilicity enhancing surfactant is preferred. Surfactants, which may for example be organic or silicone based, such as FOMREZ M66-86A (Witco) and L532 (OSi Specialties) may be used to stabilize the cell structure, to act as emulsifiers and to assist in mixing. Most preferably, the surfactant is a cell opening silicone surfactant in an amount from 1.5 to 2.5 parts by weight per 100 parts polyol.

Catalysts are used to control the relative rates of water-polyisocyanate (gas-forming or blowing) and polyol-polyisocyanate (gelling) reactions. The catalyst may be a single component, or in most cases a mixture of two or more compounds. Preferred catalysts for polyurethane foam production are organotin salts and tertiary amines. The amine catalysts are known to have a greater effect on the water-polyisocyanate reaction, whereas the organotin catalysts are known to have a greater effect on the polyol-polyisocyanate reaction. Total catalyst levels generally vary from 0 to 5.0 parts by weight per 100 parts polyol. The amount of catalyst used depends upon the formulation employed and the type of catalyst, as known to those skilled in the art. Although various catalysts may be used in the present invention, we have found that the following ranges of catalyst amounts are satisfactory: amine catalyst from 0.5 to 2.0 parts, per 100 parts polyol; and organotin catalyst from 0 to 0.7 parts, preferably from 0 to 0.3 parts, per 100 parts polyol.

Suitable urethane catalysts useful in the present invention are all those well known to the worker skilled in the art, including tertiary amines such as triethylenediamine, N-methylimidazole, 1,2-dimethylimidazole, N-methylmorpholine, N-ethylmorpholine, triethylamine, tributylamine, triethanolamine, dimethylethanolamine and bisdimethylaminodiethylether, and organotins such as stannous octoate, stannous acetate, stannous oleate, stannous laurate, dibutyltin dilaurate, and other such tin salts.

A double-cell structure may be created to replicate the appearance of natural sea sponges. Materials used to create a double cell structure may be added to the foam forming mixture. These include: castor oil derivatives, stearic acid, acetic acid and low melting point waxes. These materials create voids larger than the prevailing pores within the resulting foam structure. If used, the double-cell additive preferably is added in an amount from 0.04 to 0.21 parts per 100 parts polyol.

One or more blowing agents may be included in the foam-forming composition. The most typical blowing agent is water that may be added in amounts from 1.5 to 5.0 parts per 100 parts polyol. Alternative blowing agents are liquid carbon dioxide, volatile organic compounds, such as pentane and acetone, and chlorinated compounds, such as methylene chloride, HFC's, HCFC's and CFC's.

Optionally, other additives may be incorporated into the foam-forming composition. The optional additives include, but are not limited to, antimicrobial compounds, stabilizers, extenders, dyes, pigments, crosslinking additives, fragrances, detergents and anti-static agents. Such additives should not have a detrimental effect on the properties of the final polyurethane foam. For sponge and mop head applications, preferably an antimicrobial compound is added in an amount from 0.5 to 1.5 parts per 100 parts polyol.

To create a sponge or mop head or a medical or industrial wipe, the polyurethane foam often is laminated to another substrate, such as but not limited to a cellulose sheet, a reticulated or non-reticulated foam sheet, a cloth sheet, a non-woven textile or an abrasive plastic. Lamination may be with a hot melt or pressure sensitive adhesive, but preferably is by flame lamination. With flame lamination, a surface of the polyurethane foam is heated to softening point, and then pressed in contact with the surface of the substrate to which the foam is to be laminated. As the foam surface cools, a bond is formed.

In addition to efficacy as a wipe or sponge, the foam of the invention also may be used in medical applications, such as to preferentially filter absorb or wick impurities from various solutions. The invention is further illustrated, but not limited, by the following examples.

### EXAMPLES

Cellulose sponges were obtained. The cellulose sponges of Examples C1, C2 and C3 were from 3M, Nylonge and Spontex, respectively.

Polyurethane foams were prepared on a laboratory scale by mixing together the foam-forming ingredients and pouring them into a 15″×15″ cardboard box to form foam buns under atmospheric pressure (e.g., 1 atm.) and temperature (about 75° F.). The foam ingredients were mixed according to the proportions shown in Table 1. Amounts are in kilograms and are based on parts by weight per hundred parts polyol. The foams of Examples C4, C5, C6, C7 and C8 are comparison foams not prepared according to the invention. The foams of Examples 1 to 6 were prepared according to the invention.

Example C4 was prepared as a standard ester polyurethane foam. The foam of Example C5 was prepared with a hydrophilic polyol as 100% of the polyol. Example C6 was prepared with a conventional polyol and added a cell opening surfactant. Example C7 was prepared with a low amount of hydrophilic polyol blended with a conventional polyol, and included a cell opening surfactant. The foam of Example C8 had the same composition as that of Example C7, but Example C8 was chemically reticulated with sodium hydroxide in a post process step according to the method set out in U.S. Pat. No. 6,765,416.

The foams in Examples 1 to 6 incorporated a major portion, from 70 to 100 parts by weight, of a hydrophilic polyol. These foams also incorporated a cell opening surfactant.

TABLE 1
Polyurethane Foam Formulations

| | C4 | C5 | C6 | C7 | C8 | 1 | 2 | 3 | 4 | 5 | 6 |
|---|---|---|---|---|---|---|---|---|---|---|---|
| 1102-50A | 100.0 | 0 | 100.0 | 90.0 | 90.0 | 0 | 0 | 0 | 10.0 | 20.0 | 30.0 |
| F45 | 0 | 100.0 | 0 | 10.0 | 10.0 | 100.0 | 100.0 | 100.0 | 90.0 | 80.0 | 70.0 |
| B8301 | 0 | 0 | 1.0 | 2.0 | 2.0 | 1.5 | 1.5 | 1.5 | 1.5 | 1.5 | 1.5 |
| SE232 | 1.5 | 1.5 | 0 | 0 | 0 | 0 | 0 | 0 | 0 | 0 | 0 |
| Water | 3.8 | 4.5 | 5.0 | 3.9 | 3.9 | 4.5 | 4.0 | 3.8 | 4.6 | 4.6 | 4.6 |
| NEM | 1.2 | 1.2 | 1.2 | 0.35 | 0.35 | 1.2 | 1.2 | 1.2 | 1.3 | 1.3 | 1.3 |
| K29 | 0.1 | 0.1 | 0.25 | 0.12 | 0.12 | 0.25 | 0.25 | 0.25 | 0.15 | 1.0 | 1.0 |
| TD80 | 50.3 | 36.0 | 39.6 | 45.5 | 45.5 | 35.9 | 39.5 | 44.5 | 36.6 | 36.6 | 36.6 |
| Index | 113 | 70 | 70 | 98 | 98 | 70 | 85 | 100 | 70 | 70 | 70 |
| Density (lbs/ft³) | 1.90 | 2.06 | 1.88 | 1.61 | 1.61 | 2.18 | 2.22 | 1.80 | 2.18 | 2.25 | 2.25 |

LEXOREZ 1102-50A is an ester polyol with a hydroxyl number of 50 supplied by Inolex Chemical Company. F45 is FOMREZ 45, a 50 hydroxyl hydrophilic ester polyol offered by Crompton. Another example of a suitable hydrophilic polyol is 1105-HV2 from Inolex Chemical Company. TEGOSTAB B8301 is a cell opening silicone surfactant from Goldschmidt Chemical Corporation. Other suitable cell opening surfactants include, but are not limited to, TECOSTAB B8300 from Goldschmidt Chemical Corporation and LPX6303 from Byk Chemie. KOSMOS K29 is a stannous octoate catalyst (tin catalyst) from Goldschmidt Chemical Corporation. NEM is an amine catalyst, n-ethyl morpholine. TD80 is a toluene diisocyanate mixture comprised of 80 percent 2,4-toluene diisocyanate and 20 percent 2,6-toluene diisocyanate. The index is the isocyanate index.

Sponges were cut to a desired sample size of 4.75 inches by 3.0 inches by 0.625 inches. Before testing, cellulose sponges were washed in a washing machine for two cycles to remove water soluble materials or additives (e.g., humectants). Polyurethane foam samples were not pre-washed.

The rate of liquid absorption was determined according to the following test method. The weight and dimensions of a damp sponge sample are measured. The sponge has a generally rectangular front and rear surface and a certain thickness. The length and thickness of the sponge are measured to the nearest 0.01 inches. The sponge is wrung out and its wrung out weight is recorded. A perforated plate is placed in the bottom of a solid tray. Water is added to a depth of ⅛ inch over the perforated plate. The sponge is placed on the surface of the perforated plate and into the pool of water. One side surface of the sponge is held within the pool such that the front and rear faces of the sponge are held perpendicular to the surface of the water pool. The sponge is removed after 5 seconds, and without losing water from the sponge, the sponge is weighed. The wet weight is recorded to the nearest 0.01 grams. The rate of water absorption is reported as pounds of water per square foot per minute. It is calculated as the wet weight minus the wrung out weight divided by the length times the thickness of the sponge.

Wet out time measures the time duration required for a drop of water to be absorbed completely by a damp sponge sample. The sponge sample is immersed in water and squeezed while in the water to remove trapped air. Upon removing from the water, the sponge is wrung out as completely as possible. A drop of water is placed on a facing surface of the damp sponge. The time for the drop to be absorbed by the damp sponge is recorded. The average wet out time was calculated after the test is repeated five times.

Wipe dry is evaluated by pouring 50 grams of water on a clean level surface. The sample sponge is weighed before the test and after each wiping pass across the water until no more water is absorbed. The sponge is not wrung out before or after weighing. The weight of the water picked up by the sponge after each pass is recorded.

Water holding capacity is measured by weighing a dry sponge, then immersing the sponge sample in water, squeezing to remove trapped air, soaking the sponge for five minutes, and weighing the saturated sponge. The water holding capacity is the weight of water held per gram of sponge.

The bond strength between the foam sample and another substrate is measured in the following method according to the ASTM D3574 tear test. The foam is flame laminated to a substrate, which in the examples was a non-woven scrim. After the bond has cured at least 24 hours, the laminated composite then is cut into a strip one inch wide by ten inches long. The foam is pulled away from the other substrate to form two one-inch long tabs. These tabs are inserted into the jaws of a testing machine, such as a Zwick or Instron tension test machine. The jaws are separated at a speed of 500±50 mm/min. The pounds of force needed to separate the two layers is measured. When the bond is strong, the two layers will not completely detach from one another. Instead, the foam and/or substrate will tear, leaving foam strands still adhered to the non-foam substrate layer. A bond strength of 8 ounces and above, more preferably 10 ounces and above, has been found satisfactory for forming sponges and wipes.

TABLE 2
Comparative Test Results - Cellulose and Prior Foams

| | Sample | | | | | | | |
|---|---|---|---|---|---|---|---|---|
| | | | | | | | | C8 |
| | | | | | | | | Hydrophilic |
| | | | | C4 | C5 | C6 | C7 | chemically |
| | C1 | C2 | C3 | Standard | Hydrophilic | Hydrophilic | Hydrophilic | treated |
| | 3M | Nylonge | Spontex | ester | ester | ester | Ester | ester |
| Rate of | 25.1 | 31.7 | 21.4 | 2.3 | 5.2 | 10.8 | 8.5 | 46.5 |
| absorption | | | | | | | | |
| Lb/ft²/min | | | | | | | | |
| Wet out | Instantly | Instantly | Instantly | >5 | ˜3 minutes | Instantly | Instantly | Instantly |
| time | | | | minutes | | | | |
| Wipe Test | | | | | | | | |
| First pass | 48.8 g | 49.4 g | 44.8 g | 9.1 g | 23 g | 25 g | 14.0 g | 49.3 g |
| Second | 47.1 g | 48.2 g | 48.7 g | 14.8 g | 36 g | 36 g | 32.8 g | 49.2 |
| pass | | | | | | | | |
| Third pass | | | 48.6 g | 19.1 g | 44 g | 43 g | 37.8 g | |
| Fourth | | | | 24.5 g | 45 g | 45 g | 41.2 g | |
| pass | | | | | | | | |
| Water | 14.2 | 13.0 | 16.5 | 26.8 | 33.6 | 31.7 | 23.3 | 31.9 |
| holding | | | | | | | | |
| capacity | | | | | | | | |
| (g/g foam) | | | | | | | | |
| Density | 3.52 | 3.91 | 3.77 | 1.90 | 2.06 | 1.88 | 1.61 | 1.61 |
| (pcf) | | | | | | | | |

TABLE 3
Comparative Test Results - Inventive Foams

| | Sample | | | | | | | | | | | |
|---|---|---|---|---|---|---|---|---|---|---|---|---|
| | 1 | | 2 | | 3 | | 4 | | 5 | | 6 | |
| Rate of | 32.5 | | 21.4 | | 26.6 | | 25.1 | | 23.2 | | 20.1 | |
| absorption | | | | | | | | | | | | |
| Lb/ft²/min | | | | | | | | | | | | |
| Wet out | 1 | second | 1 | second | 1 | second | 1 | second | 1 | second | 1 | second |
| time | | | | | | | | | | | | |
| Wipe Test | | | | | | | | | | | | |
| First pass | 30.3 | g | 22.2 | g | 20.4 | g | 24.3 | g | 22.5 | g | 24.6 | g |
| Second pass | 38.4 | g | 30.1 | g | 29.9 | g | 40.5 | g | 38.2 | g | 39.6 | g |
| Third pass | 44.1 | g | 34.0 | g | 35.2 | g | 44.8 | g | 43.2 | g | 45.1 | g |
| Fourth pass | 45.6 | g | 38.5 | g | 37.9 | g | 45.6 | g | 45.6 | g | 46.6 | g |
| Fifth pass | 46.3 | g | 41.9 | g | 40.5 | g | 45.5 | g | 45.8 | g | 45.8 | g |
| Water | 30.1 | | 27.2 | | 28.9 | | 29.1 | | 29.2 | | 27.2 | |
| holding | | | | | | | | | | | | |
| capacity | | | | | | | | | | | | |
| (g/g foam) | | | | | | | | | | | | |
| Bond | 23.5 | oz | 20.4 | oz | 19.2 | oz | 2.2 | oz | 1.9 | oz | 12.6 | oz |
| Strength | | | | | | | | | | | | |

Referring to the data presented in Tables 2 and 3, the foams according to the invention (Examples 1-6) had excellent absorption rates and performed comparable to cellulose sponges (Examples C1, C2 and C3). The foam of Example 1 is the most hydrophilic of the inventive examples. This foam absorbs the most water when used as a wipe or sponge, and has the highest rate of water absorption, which unexpectedly exceeded the rate measured for the cellulose sponges (Examples C1 to C3). Although the foams of Examples 2 and 3 did not absorb quite as much water in the wiping test as the Example 1 foam, their rate of water absorption is improved over comparative prior hydrophilic foams such as Examples C5 and C6.

The foams of Examples 4 to 6 show the effect when a portion of the hydrophilic polyol is replaced with a conventional polyol.

For Examples 1 to 6, the water absorption and water holding properties are much improved over conventional polyester polyurethane foams, and are nearly as good as polyester foams that have been chemically treated (Example C8). Hence, this invention provides satisfactory hydrophilic performance without the need for chemical reticulation post-processing, or the associated rinsing and drying operation.

The invention has been illustrated by detailed description and examples of the preferred embodiments. Various changes in form and detail will be within the skill of persons skilled in the art. Therefore, the invention must be measured by the claims and not by the description of the examples or the preferred embodiments.

We claim:

1. A method for making a hydrophilic polyester polyurethane foam, comprising:
(a) forming a polyurethane foam by mixing together the following components:
(i) 100 parts by weight of a polyol or mixture of polyols, wherein at least about 40 parts by weight of such polyol or mixture of polyols comprises a hydrophilic polyester polyol with an hydroxyl number of 40 to 100;
(ii) at least about 30 parts by weight, based on 100 parts polyol, of an isocyanate, wherein the isocyanate index is from 60 to 110; and
(iii) up to about 3.0 parts by weight, based on 100 parts polyol, of a cell opening surfactant;
wherein the hydrophilic polyester polyurethane foam has a water absorption rate of at least 20 pounds of water per square foot per minute.

2. The method of claim 1, wherein the polyol or mixture of polyols comprises at least about 70 parts by weight of a hydrophilic polyester polyol with an hydroxyl number of 40 to 100.

3. The method of claim 2, wherein the hydrophilic polyester polyol made from an adipic acid and a polyethylene glycol.

4. The method of claim 1 wherein 100 parts of the polyol or mixture of polyols comprises a single polyol that is a hydrophilic polyester polyol with an hydroxyl number of 40 to 100.

5. The method of claim 1, wherein the isocyanate is selected from the group consisting of toluene diisocyanates, methylene diisocyanates, and mixtures of such isocyanates.

6. The method of claim 1, wherein the cell opening surfactant is a silicone surfactant.

7. The method of claim 1, further comprising from 1.0 to 5.0 parts by weight, based on 100 parts polyol, of a blowing agent as a component.

8. The method of claim 7, wherein the blowing agent is water.

9. The method of claim 1, further comprising a catalyst selected from the group consisting of: gel catalysts and gas forming catalysts, and mixtures thereof.

10. The method of claim 1, further comprising from 0.5 to 2.0 parts of a blow catalyst and from 0 to 0.3 parts of a gel catalyst.

11. The method of claim 1, wherein the hydrophilic polyester polyurethane foam has pore sizes in the range of 60 to 130 pores per linear inch.

12. The method of claim 1, wherein the isocyanate index is about 70 to 90.

13. The method of claim 1, wherein the hydrophilic polyester polyurethane foam has a water absorption rate of at least 25 pounds of water per square foot per minute.

14. The method of claim 1, wherein the hydrophilic polyester polyurethane foam has such water absorption rate without a chemical reticulation step.

15. The method of claim 1, wherein the hydrophilic polyester polyurethane foam is flame laminatable to a substrate to achieve a bond strength of at least about 8 ounces.

16. A hydrophilic polyester polyurethane foam made according to the method of claim 1.

17. An absorbent article incorporating the hydrophilic polyester polyurethane foam of claim 16.

18. A method for making an absorbent article, comprising:
(a) forming a hydrophilic polyurethane foam by mixing together the following components:
(i) 100 parts by weight of a polyol or mixture of polyols, wherein at least about 40 parts by weight of such polyol or mixture of polyols comprises a hydrophilic polyester polyol with an hydroxyl number of 40 to 100;
(ii) at least about 30 parts by weight, based on 100 parts polyol, of an isocyanate, wherein the isocyanate index is from 60 to 110; and
(iii) up to about 3.0 parts by weight, based on 100 parts polyol, of a cell opening surfactant;
wherein the hydrophilic polyester polyurethane foam has a water absorption rate of at least 20 pounds of water per square foot per minute; and
(b) laminating the hydrophilic polyester polyurethane foam to a substrate.

19. The absorbent article of claim 18, wherein the laminating step is by flame lamination.

20. The absorbent article of claim 18, wherein the hydrophilic polyester polyurethane foam has such water absorption rate without a chemical reticulation step.

21. The absorbent article of claim 18, wherein the hydrophilic polyester polyurethane foam has a water absorption rate of at least 25 pounds of water per square foot per minute.
